(19) United States
(12) Patent Application Publication
(10) Pub. No.: US 2007/0114086 A1
(43) Pub. Date: May 24, 2007

(54) VEHICLE PROPULSION SYSTEM AND VEHICLES ADAPTED TO INCLUDE PROPULSION SYSTEM

(76) Inventor: Robert Glessner, Frederick, MA (US)

Correspondence Address: WRB-IP LLP, 1217 KING STREET, ALEXANDRIA, VA, 22314, US

(21) Appl. No.: 11/162,781

(22) Filed: Sep. 22, 2005

(51) Int. Cl. B62M 23/02

(52) U.S. Cl. 180/205

(57) ABSTRACT

A propulsion system includes a first torque transmission element and a second torque transmission element, the first torque transmission element being adapted to transmit torque to the second torque transmission element. The propulsion system further includes a first torque transmission element crank coupled to the first torque transmission element by a bearing arrangement that transmits torque to the first torque transmission element when the first torque transmission element crank is turned in a first rotational direction about an axis of the first torque transmission element and that permits the first crank to be turned freely relative to the first torque transmission element when the first torque transmission element crank is turned in a second rotational direction. A vehicle comprising a propulsion system and a bicycle are also disclosed.

The present invention relates generally to a vehicle propulsion system and to vehicles adapted to include such a propulsion system.

A conventional bicycle 21 is shown in FIG. 1. The bicycle 21 has a frame 23 that ordinarily defines a generally planar shape. The frame 23 comprises a top tube 25, a down tube 27, a head tube 29 to which both the top tube and down tube are secured, such as by brazing, and a seat tube 31 that is secured to a rear end of the top tube and, at a bottom bracket 33, to the down tube. A front fork 35 is pivotably attached to the head tube 29, and a head set 37 comprising a stem 39 that is secured to a top steering column portion of the front fork at the top end of the head tube. A handlebar 41 is attached to the stem 39. A rider turns a front wheel 43 attached to the front fork 35 relative to a plane defined by the frame 23 by turning the handlebar 41 which, in turn, turns the stem 39 and the front fork.

An axle (not shown) extends through and is rotatably mounted to the bottom bracket 33 in rotary bearings (not shown). The axle extends perpendicular to the plane of the frame 23. Left and right cranks 44 are attached to opposite ends of the axle on opposite sides of the bottom bracket 33 and extend generally perpendicularly to the axle. Pedals 45 are typically attached to the cranks 44. One or more chain wheels 47 are non-rotatably secured to the axle, such as by a “spider” 49.

A rear wheel 51 is rotatably secured to a portion of the frame 23 at an end of a chain stay 53 by an arrangement referred to as a freewheel 55 which permits a driving force to be transmitted to the rear wheel in one rotation direction only. Different types of freewheels are available, such as those described in U.S. Pat. No. 5,186,377, which is incorporated by reference. An endless chain 59 extends around the chain wheels 47 and the freewheel gears 57 attached to an outer part (not shown) of the freewheel 55. Typically, the outer part of the freewheel 55 spins freely in one direction (e.g., counter-clockwise when the bicycle is viewed from the right side) relative to an inner part (not shown) which can be fixed to a hub of the rear wheel 51. Thus, when a rider pedals backwards, the rear wheel is not forced to rotate backwards and, when the rear wheel is turning clockwise, the rear wheel does not cause the cranks 44 to rotate, i.e., the rider can coast. The outer part of the freewheel 55 locks when turned in the other direction (clockwise) relative to the inner part. Thus, when a rider pedals in one direction and thereby causes the chain wheels 47 to turn clockwise, the chain 59 is turned clockwise, which turns the freewheel gears 57, the inner and outer parts of the freewheel 55, and the rear wheel 51 clockwise, thus propelling the bicycle forward.

It is desirable to provide a bicycle or similar vehicle with a propulsion system that facilitates the use of the rider's arms to propel the vehicle, either with or without the use of the rider's legs.

In accordance with an aspect of the present invention, a propulsion system comprises a first torque transmission element, a second torque transmission element, the first torque transmission element being adapted to transmit torque to the second torque transmission element, and a first torque transmission element crank coupled to the first torque transmission element by a bearing arrangement that transmits torque to the first torque transmission element when the first torque transmission element crank is turned in a first rotational direction about an axis of the first torque transmission element and that permits the first crank to be turned freely relative to the first torque transmission element when the first torque transmission element crank is turned in a second rotational direction.

In accordance with another aspect of the present invention, a rider propelled vehicle comprises a vehicle frame including a bracket, a wheel rotatably mounted on the vehicle frame, and a propulsion system attached to the bracket. The propulsion system comprises a first torque transmission element, and a first torque transmission element crank coupled to the first torque transmission element by a freewheel that transmits torque to the first torque transmission element when the first torque transmission element crank is turned in a first rotational direction about an axis of the first torque transmission element and that permits the first torque transmission element crank to be turned freely relative to the first torque transmission element when the first torque transmission element crank is turned in a second rotational direction, and a second torque transmission element, the first torque transmission element being adapted to transmit torque to the second torque transmission element. The vehicle further comprises a chain wheel coupled to the second torque transmission element, the second torque transmission element being coupled to the chain wheel such that torque is transmitted between the second torque transmission element and the chain wheel when the first torque transmission element is turned in the first rotational direction, a sprocket attached to the wheel, and an endless chain extending around the chain wheel and the sprocket.

In accordance with another aspect of the present invention, a bicycle comprises a frame comprising a top tube, a down tube, and a seat tube connected between the top tube and the down tube, a fork comprising a steering column, and a head tube assembly comprising a steering yoke attached to the top tube and the down tube, a stem and a bottom plate pivotably attached to a top end and a bottom end of the steering yoke, respectively, a tube attached at top and bottom ends thereof to the stem and the bottom plate, respectively, the steering column extending into and being fixed relative to the tube.

### BRIEF DESCRIPTION OF THE DRAWINGS

The features and advantages of the present invention are well understood by reading the following detailed description in conjunction with the drawings in which like numerals indicate similar elements and in which:

FIG. 1 is a side view of a conventional bicycle;

FIG. 2 is a side view of a vehicle including a propulsion system according to an embodiment of the present invention;

FIG. 3 is a side, partially cross-sectional view of a portion of a vehicle including a propulsion system according to an embodiment of the present invention;

FIG. 4 is a side, partially cross-sectional view of a portion of a propulsion system according to an embodiment of the present invention;

FIG. 5 is a top, partially cross-sectional view of a portion of a propulsion system according to an embodiment of the present invention;

FIG. 6 is an exploded, partially cross-sectional view of a portion of a propulsion system according to an embodiment of the present invention;

FIG. 7A is a side, partially cross-sectional view of a head assembly according to an embodiment of the present invention;

FIG. 7B is a top view of portions of a head assembly;

FIG. 7C is a top, cross-sectional view of the head assembly of FIG. 7A taken at section 7C-7C;

FIG. 8 is a side view of a portion of a head assembly according to an embodiment of the present invention;

FIG. 9 is a front view of a yoke of a head assembly according to an embodiment of the present invention;

FIG. 10 is a rear view of a yoke of a head assembly according to an embodiment of the present invention;

FIG. 11 is an exploded view of portions of a head assembly according to an embodiment of the present invention;

FIG. 12 is a top view of a steering arrangement according to an embodiment of the present invention;

FIG. 13 is a top view of the steering arrangement of FIG. 12 with levers of the arrangement removed; and

FIG. 14 is a top view of a steering arrangement according to another embodiment of the present invention.

### DETAILED DESCRIPTION

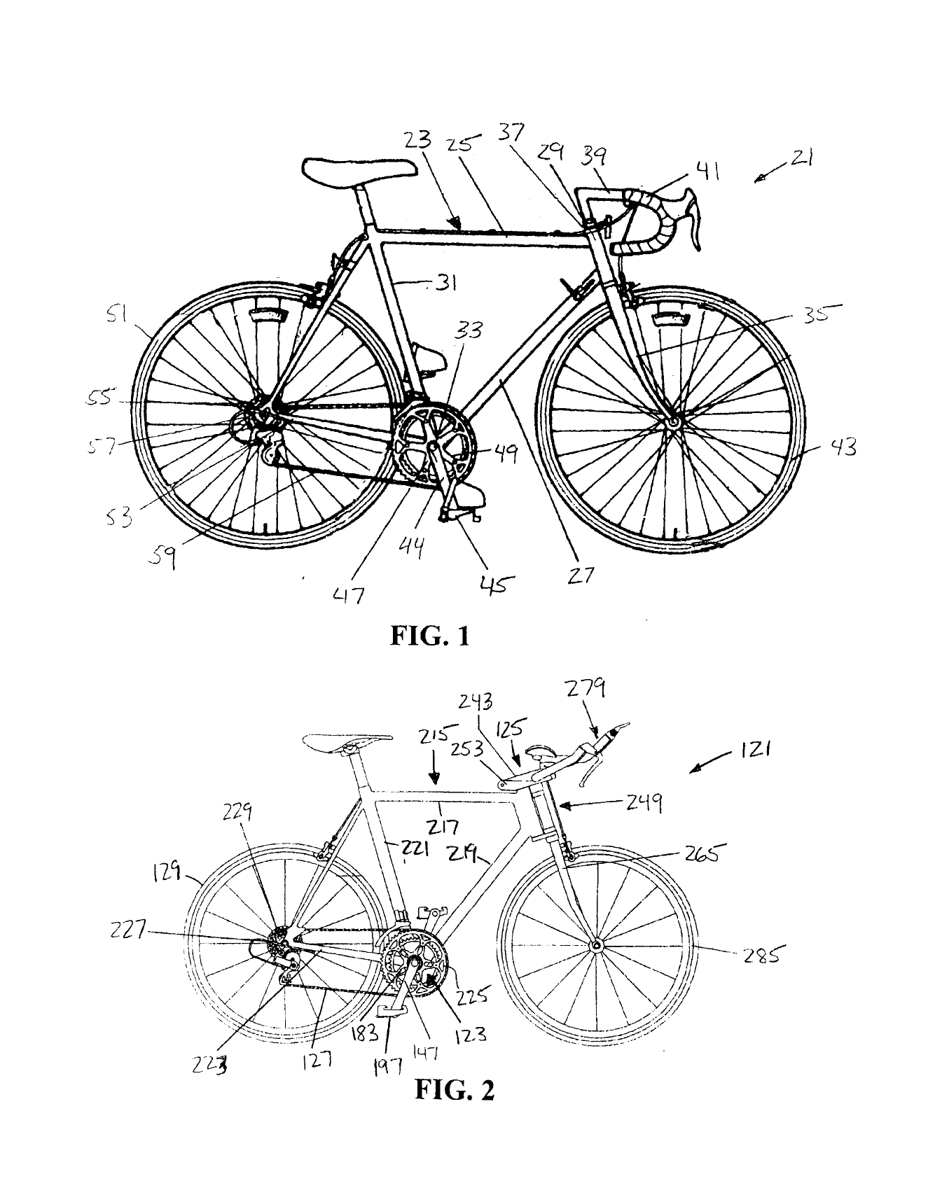

FIG. 2 shows a bicycle 121 according to an embodiment of the present invention. The bicycle 121 comprises a propulsion system 123 according to an embodiment of the present invention. The bicycle 121 is in many respects similar to conventional bicycles such as the bicycle 21 described in connection with FIG. 1. However, the propulsion system 123 facilitates use of the rider's arms to propel or assist in propelling the bicycle. In the illustrated embodiment, the rider pivots a specially adapted arm or lever arrangement 125 that can be similar in appearance to and function like conventional “aerobars”. The propulsion system 123 includes an arrangement coupling the lever arrangement 125 ultimately to the pedal axle (not shown in FIG. 2) so that pivoting of the levers causes the chain 127 to turn and drive the rear wheel 129.

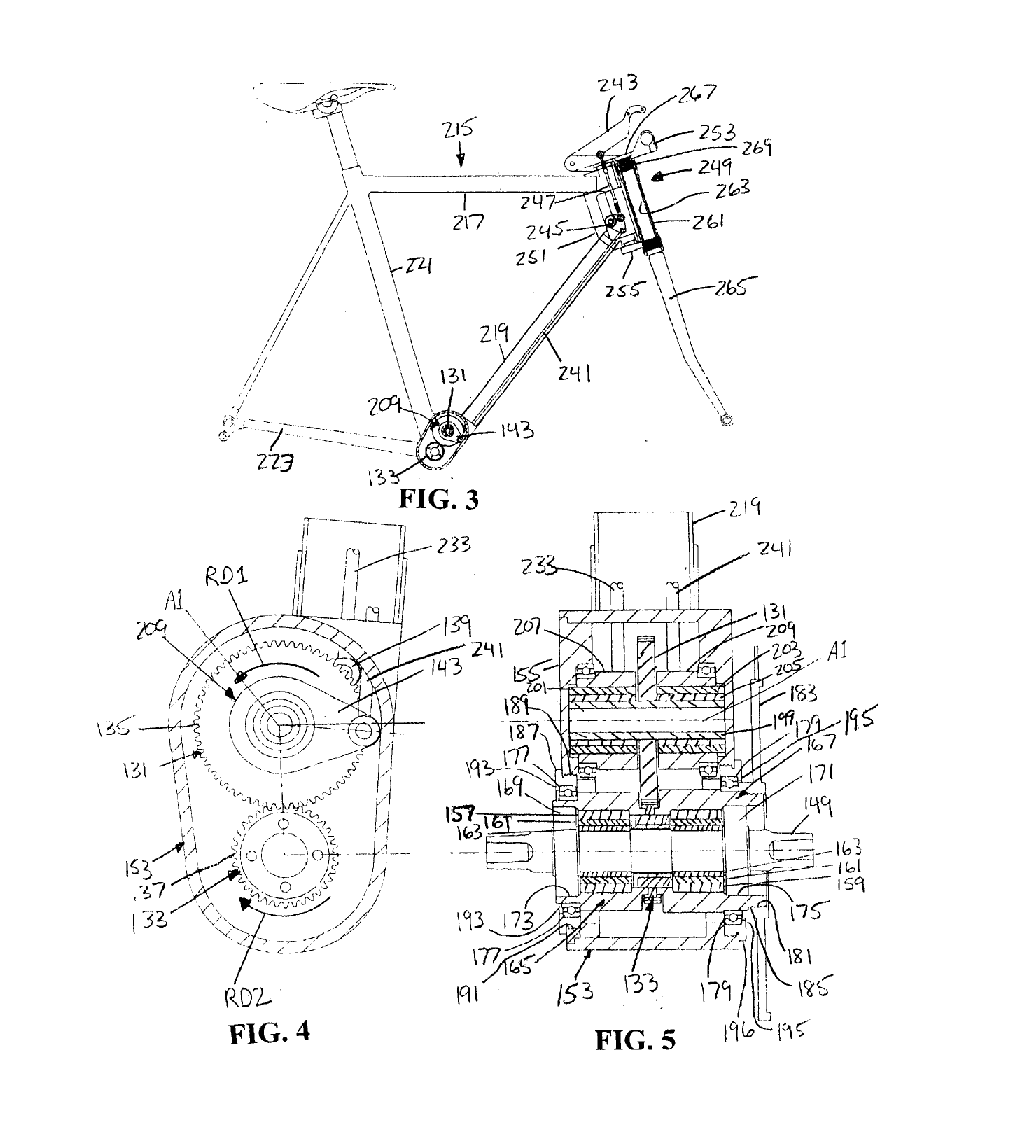

Basic features of a propulsion system 123 according to an embodiment of the present invention are seen in FIGS. 3-6. The propulsion system 123 comprises torque transmission elements such as a first gear 131 and a second gear 133, it being understood that other forms of torque transmission elements could be used instead of gears, such as rollers and belts, and sprockets and chains. However, for purposes of describing torque transmitting elements in an embodiment of the present invention, gears are used as an example.

Teeth 135 and 137 of the first gear 131 and the second gear 133 mesh. A first gear crank 139 is coupled to the first gear 131 by an arrangement including a freewheel or freewheel-type bearing arrangement such as a roller clutch that transmits torque to the first gear when the first gear crank is turned in a first rotational direction RD1 (FIG. 4) about an axis A1 of the first gear and that permits the first crank to be turned freely relative to the first gear when the first gear crank is turned in a second rotational direction RD2 (FIG. 4).

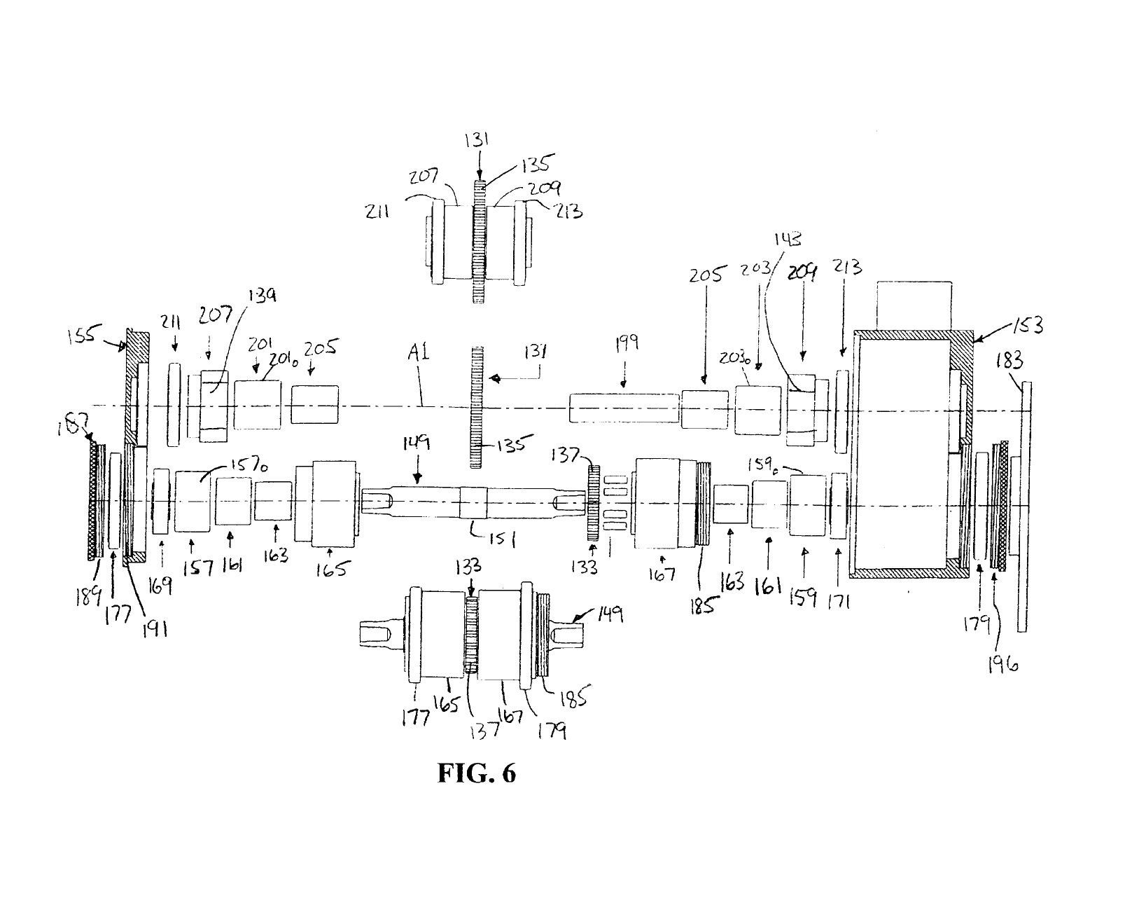

The second first gear crank 143 can be coupled to the first gear 131 by an arrangement including a freewheel or freewheel-type bearing arrangement as seen in the exploded view in FIG. 6 that transmits torque to the first gear when the second first gear crank is turned in the first rotational direction RD1 about the axis A1 of the first gear and that permits the second first gear crank to be turned freely relative to the first gear when the second first gear crank is turned in the second rotational direction. Ordinarily, the second first gear crank 143 will be disposed on an opposite side of the first gear 131 than the first gear crank 139, and will be coupled to the first gear by a different bearing arrangement than the first gear, however, the first gear crank and the second first gear crank can be disposed on the same side of the first gear and/or can be coupled to the first gear by the same bearing arrangement.

A second gear crank 147 (FIG. 2) is coupled to the second gear 133, such as by an axle 149. The second gear crank 147 can be coupled to the second gear 133 by an arrangement including a freewheel or freewheel-type bearing arrangement (not shown) that transmits torque between the axle and the second gear only when the second gear crank is turned in the second rotational direction RD2. Ordinarily, the second gear crank 147 is coupled to the second gear 133 such that torque is transmitted to the second gear when the second gear crank is turned in either the first or the second rotational directions RD1 or RD2, such as by a non-circular portion 151 (FIG. 6) of the axle 149 being received in a corresponding non-circular opening (not shown) in the second gear.

The propulsion system 123 shown in FIGS. 3-6 is largely disposed inside of a housing 153 including a housing cover 155. The second gear 133 and the axle 149 can be held in position relative to the housing 153 and cover 155 by freewheel-type bearing arrangements such as left and right roller clutches 157 and 159 and, if desired, rings 161 and bushings 163 fixed between the inner surfaces of the roller clutches and the outer surface of the axle 149. Radially inner portions (not shown) of the roller clutches 157 and 159 are ordinarily non-rotatable or substantially non-rotatable relative to the axle 149 while radially outer portions are rotatable in one direction and non-rotatable in another direction such that torque is transmitted between the axle and the outer portion of the roller clutches only when the second gear crank 147 is turned in the second rotational direction RD2.

Outer portions 157o and 159o of the left and right roller clutches 157 and 159 are ordinarily non-rotatable relative to left and right clutch housings 165 and 167. The left and right clutch housings 165 and 167 and the second gear 133 are secured in axial positions by left and right inner bearings 169 and 171 mounted the axle 149 and sandwiching the left and right clutch housings and the second gear. The left and right inner bearings 169 and 171 are received in left and right recesses 173 and 175 (FIG. 5) in the left and right clutch housings 165 and 167, respectively, and permit free rotation of the axle 149 relative to the left and right clutch housings. The left and right clutch housings 165 and 167 are held in position relative to the housing 153 and the cover 155 by left and right outer bearings 177 and 179. An internally threaded portion 181 of a spider 183 or a chainwheel is secured to an externally threaded portion 185 of the right clutch housing 167. The cover 155 includes a cap 187 with an externally threaded portion 189 that mates with an internally threaded portion 191 of the housing cover. The left bearing 177 abuts an extending flange portion 193 of the cap 187 and the right bearing 179 abuts an extending flange portion 195 of a housing cap 196 with external threads that mate with internal threads on an opening in the housing 153. The cover cap 187 and the housing cap 196 assist in holding the second gear 133, axle 149 and associated components in place in the housing 153. The cover 155 is secured to the housing 153 in any suitable manner, such as by bolts (not shown) that extend through holes in the cover into threaded openings in the housing. Pedals 197 (FIG. 2) are typically attached to second gear cranks 147 on opposite ends of the axle 149.

Turning to the first gear 131 and the first gear crank 139 and the second first gear crank 143, a pin 199 extends through and is non-rotatable relative to the first gear 131, such as by having a non-circular cross-section that is received in a corresponding non-circular opening in the gear, by providing a key (not shown), or the like. The pin 199 defines the axis A1 of the first gear 131. The pin 199 is fixed to inner portions of freewheel-type bearing arrangements such as left and right roller clutches 201 and 203 on opposite sides of the first gear 131. As with the roller clutches 165 and 167, structures such as rings 205 and bushings can be disposed between the inner surfaces of the roller clutches 201 and 203 and the outer surface of the pin 199. Outer surfaces 201o and 203o of the left and right roller clutches 201 and 203 are attached to inner surfaces of left and right arm clutch housings 207 and 209. The left and right arm clutch housings 207 and 209 are axially fixed in position and are ordinarily freely rotatable (and at least pivotable) relative to the housing 153 and cover 155 by means of left and right outer bearings 211 and 213 between the left and right arm clutch housings and supporting surfaces of the housing and the cover. The left and right arm clutch housings 207 and 209 have the first gear crank 139 and the second first gear crank 143 extending therefrom, respectively. The first gear crank 139 and the second first gear crank 143 can be formed integrally with the left and right arm clutch housings or can be fixed to them by any suitable means, such as by fasteners, adhesive, and the like.

By pivoting the first gear crank 139 and the second first gear crank 143, the left and right arm clutch housings 207 and 209 pivot, respectively. When the left and right arm clutch housings 207 and 209 pivot, the outer portions 201o and 203o of the left and right roller clutches 201 and 203 pivot, respectively.

When the first gear crank 139 and the second first gear crank 143 pivot in the first rotational direction RD1, the left and right roller clutches 201 and 203—inner and outer portions—pivot in the first rotational direction, and cause the pin 199 to pivot in the first rotational direction about the axis A1. The pivoting of the pin 199 about the axis A1 causes the first gear 131 to pivot in the first rotational direction about the axis A1.

By contrast, when the first gear crank 139 and the second first gear crank 143 pivot in the second rotational direction RD2, only the outer portions 201o and 203o of the left and right roller clutches 201 and 203 pivot in the second rotational direction. The inner portions of the left and right roller clutches 201 and 203 do not pivot, and the pin 199 does not pivot about the axis A1. Thus, by pivoting the first gear crank 139 and the second first gear crank 143 in the first rotational direction, torque is transmitted to the first gear. Torque is not transmitted when the first gear crank 139 and the second first gear crank 143 are pivoted in the second rotational direction RD2. Thus, reciprocating piston-like movements of the first gear crank 139 and the second first gear crank 143 can transmit torque from the first gear crank and the second first gear crank to the first gear 131. The first gear 131 turns the second gear 133 which can be used to drive the rear wheel 129. Thus, a rider can drive the rear wheel 129 by: turning the second gear crank 147 as in a conventional bicycle; reciprocating one or both of the first gear crank 139 and the second first gear crank 143; or both turning the second gear crank and reciprocating one or both of the first gear crank and the second first gear crank.

The propulsion system 123 has been described in connection with an embodiment wherein a first gear crank 139 and a second gear crank 143 are disposed on opposite, or left and right, sides of a first gear 131, and wherein clutch housings 165 and 167 and other components are disposed on left and right sides of a second gear 133. It will be appreciated, however, that all components can be disposed on a right or a left side of the gears, and that, instead of providing two, i.e., left and right, sets of components, the power transmission can be operated with one set of the components described, or with additional sets of components, as desired.

In addition, while the propulsion system 123 has been described in connection with an embodiment wherein torque is transmitted between two gears, additional torque transmitting elements may be provided. For example, a plurality of sprockets and a chain might be provided instead of the first and/or the second gears, and gear ratios between sprockets can be shifted in substantially the same manner that gear ratios are shifted between the chainwheel and the freewheel gears on a conventional bicycle. Further, the torque transmitting elements need not necessarily transmit torque in a single direction, i.e., torque transmitting elements such as helical gears having rotational axes disposed at angles relative to each another may be used.

As seen in FIGS. 2 and 3, the bicycle 121 comprising the propulsion system 123 has a frame 215 comprising a top tube 217, a down tube 219, a seat tube 221, and a chain stay 223. A chainwheel 225 (FIG. 2) is mounted to the spider 183, a freewheel 227 with one or more freewheel gears 229 is disposed at an end of the chain stay 223, and a chain 231 extends around the chainwheel and the freewheel gear or gears. The gear ratios between one or more chainwheel sprockets and one or more freewheel gears can be shifted in any suitable conventional manner. The rear wheel 129 is mounted at the end of the chain stay 223 in the conventional manner.

FIGS. 2-3 show a conventional bicycle modified so that the down tube 219, the seat tube 221, and the chain stay 223 are secured to a specially provided housing 153 for the propulsion system 123. The tubes may be secured to the housing in any suitable manner, such as by being received in tubular openings provided for the tubes and secured in place by welding, brazing, adhesives, mechanical fasteners, or the like. Of course, a bicycle frame may be specially made for the components of the propulsion system 123 such that they need not necessarily be disposed in a housing as described here.

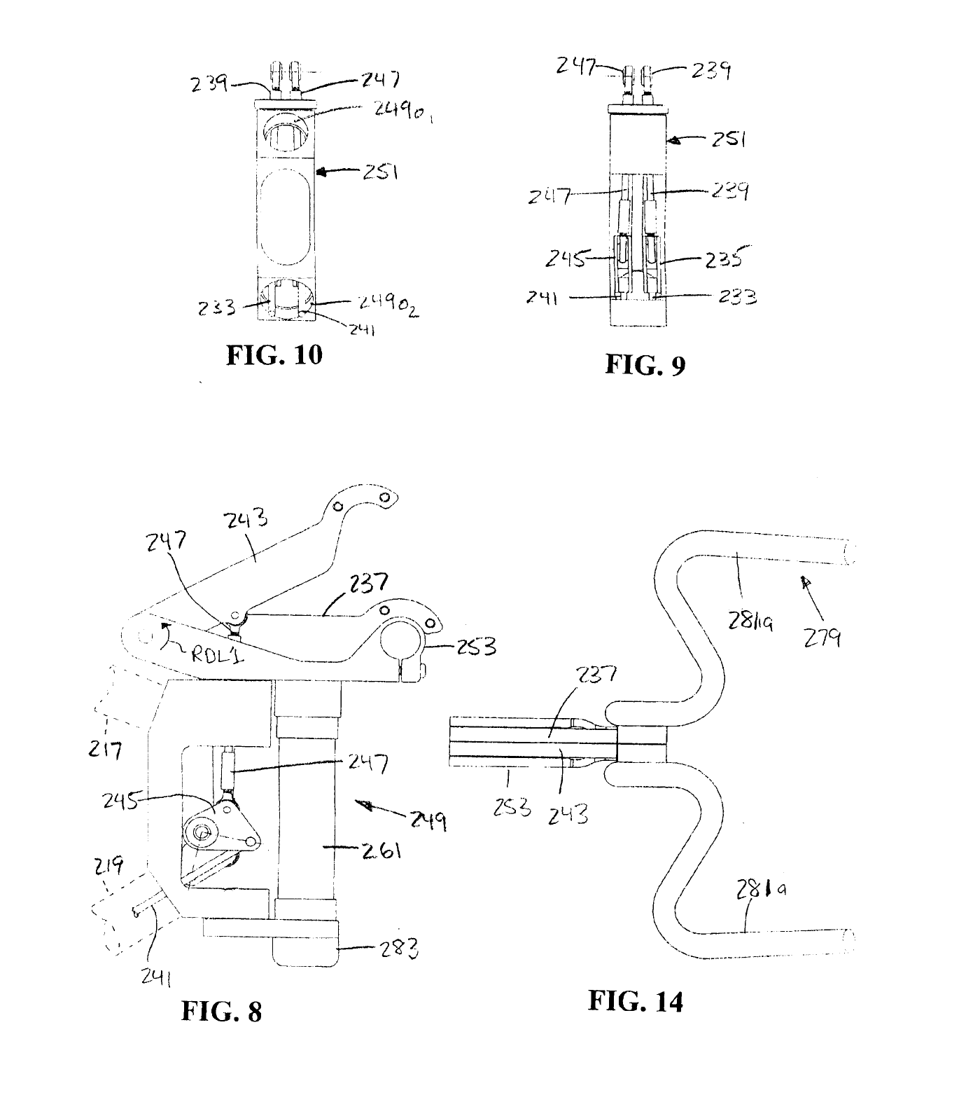

As seen in FIG. 4, a crank rod 233 is pivotably attached to the first gear crank 139 remote from the axis A1 of the first gear 131. The crank rod 233 extends out of the housing 153 and into one end of the down tube 219 and, ordinarily, out the other, where it can be pivotably attached to a pivot member 235 (FIG. 9) that will ordinarily be pivotably attached to a component of the bicycle frame 215. A lever 237 (FIGS. 8 and 11) of the lever arrangement 125 is also pivotably mounted relative to the frame 215 and linked to the crank rod 233, ordinarily by the pivot member 235 and a linkage member 239, such that pivotal movement of the lever is adapted to turn the first gear crank 139 in the first rotational direction. The lever 237 is ordinarily mounted indirectly to the frame 215.

A single crank rod 233 can be used to turn both the first gear crank 139 and the second first gear crank 143, however, ordinarily a left and a right crank rod 233 and 241 are pivotably connected to the first gear crank and the second first gear crank, respectively. As seen generally in FIGS. 3 and 7A-11, the left and the right crank rods 233 and 241 are linked to left and right levers 237 and 243, respectively, by left and right pivot members 235 and 245 and left and right pivot members 239 and 247.

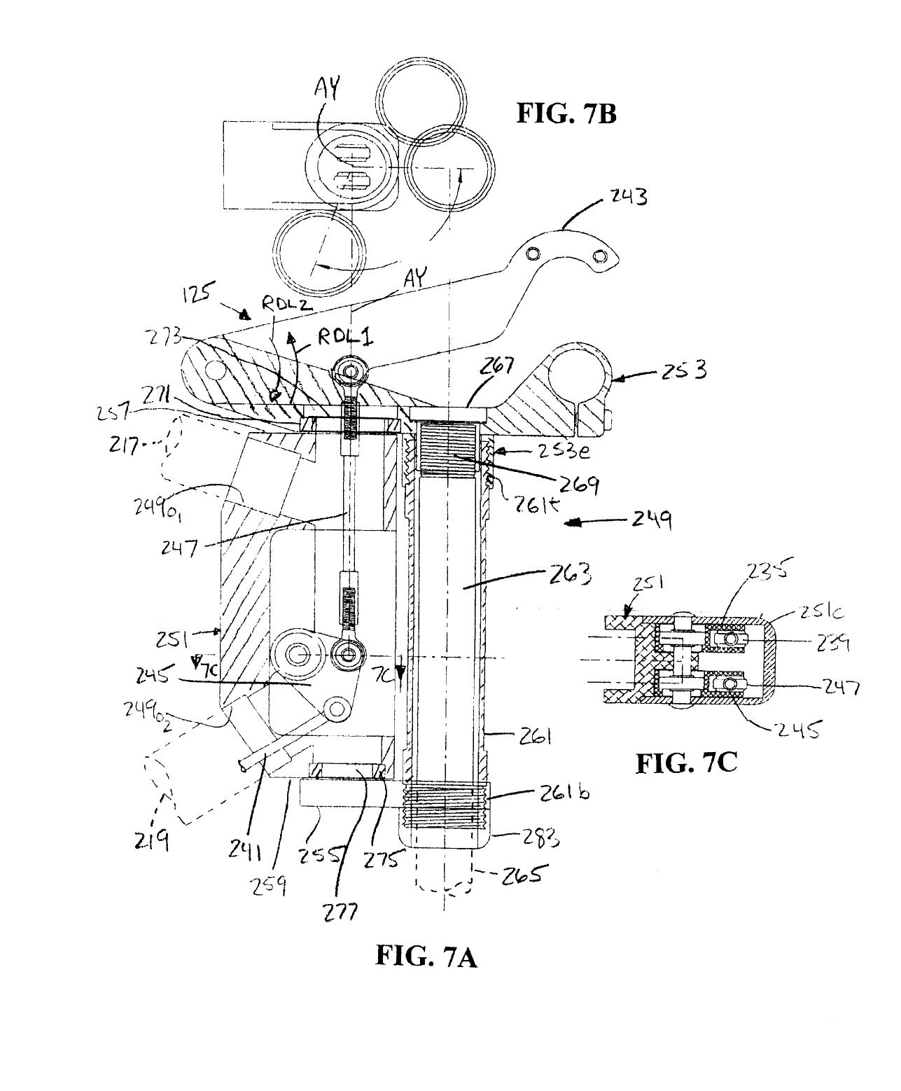

Pivotal movement of the levers 237 and 243 in one of the first or second lever rotational directions RDL1 and RDL2 turns the first gear crank 139 and the second first gear crank 143 in the first rotational directions RD1, while turning the levers in the opposite direction does not turn the first gear crank. In the illustrated embodiment, turning the levers 237 and 243 in the first lever rotational direction RDL1 turns the first gear crank 139 and the second first gear crank 143 in the first rotational direction RD1, and the first lever rotational direction and the first rotational direction are the same rotational directions in the same planes. The right lever 243 moves in the first lever rotational direction RDL1 from the position illustrated in FIG. 7A to the position illustrated in FIG. 8. As it does so, the linkage 247 is caused to move upward and pivots the pivot member 245 which, in turn, pulls on the right hand crank rod 241. It will be appreciated, however, that the levers can be linked to the first gear crank and the second first gear crank by a variety of different linkage arrangements such that rotation of the levers in the second lever rotational direction turns the first gear crank and the second first gear crank in the first rotational direction, and the second lever rotational direction may be in a plane different than the plane of the first rotational direction.

While the illustrated embodiment shows levers 237 and 243 linked to the crank rods 233 and 241 by a pivot member 235 and 245 and a linkage member 239 and 247, it will be appreciated that the levers can be pivotably connected directly to the crank rods. While the illustrated embodiment shows crank rods 233 and 241 extending through the down tube 219, the crank rods may be disposed outside of the downtube. If a housing is provided, the crank rods may extend into the housing through openings for the crank rods.

The left and right levers 237 and 243 are pivotably mounted to the bicycle 121. In the illustrated embodiment, the levers are pivotably mounted to a specially adapted head assembly 249, as seen in FIGS. 7A-8 and 10. The head assembly 249 comprises a steering yoke 251 attached to the top tube 217 and the down tube 219. The top tube 217 and the down tube 219 can be connected in any suitable manner, much like the down tube, the seat tube 221, and the chain stay 223 are connected to the housing 153. For example, FIGS. 7A and 10 show openings 249o₁ and 249o₂ in which the top tube 217 and the down tube 219 can be secured. In the illustrated embodiment, the crank rods 233 and 241 extend out of the down tube 219 and are pivotably attached to pivot members 235 and 245 that are pivotably attached to the steering yoke 251.

The head assembly 249 further comprises what shall be referred to as a stem 253 and a bottom plate 255 pivotably attached to a top end 257 and a bottom end 259 of the steering yoke, respectively, and a tube 261 attached at top and bottom ends thereof to the stem and the bottom plate, respectively. A steering column 263 of a fork assembly 265 extends into and is fixed relative to the tube 261 in any suitable manner, such as by a nut and washer arrangement 267 attachable around a threaded end 269 of the steering column, and that secures the fork assembly relative to the stem 253. The stem 253 and the bottom plate 255 can be pivotably attached to the top end 257 and the bottom end 259 of the steering yoke 251 in any suitable manner, such as by a top bearing 271 and spool 273 receivable in openings (not shown) in the top end of the steering yoke and the stem, and a bottom bearing 275 and spool 277 receivable in openings (not shown in the bottom end of the steering yoke and the bottom plate.

The linkages 239 and 247 can extend from the pivot members 235 and 245 through the top bearing 271 and spool 273 and can be pivotably connected to the levers 237 and 243. The levers 237 and 243 can, in turn, be pivotably connected to the stem 251 at some point remote from the point at which the linkage members 239 and 243 are pivotably attached. The levers 237 and 243 can take any desired form, such as being in a shape and position to function like aerobars. By providing the linkages 239 and 247 in the form of eye bolts that mate with internally threaded rods as seen in FIG. 7A, as seen in FIG. 7B, the tube 261 and fork 265 can be moved a substantial amount about an axis AY extending through the yoke 251.

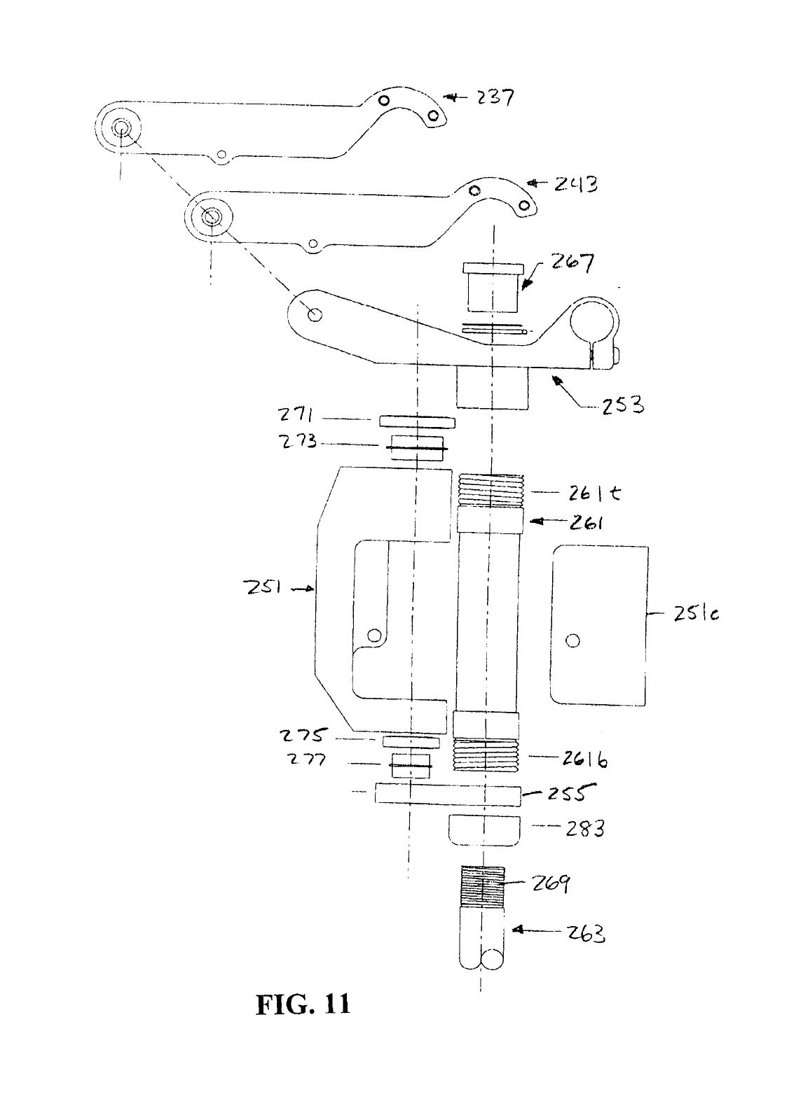

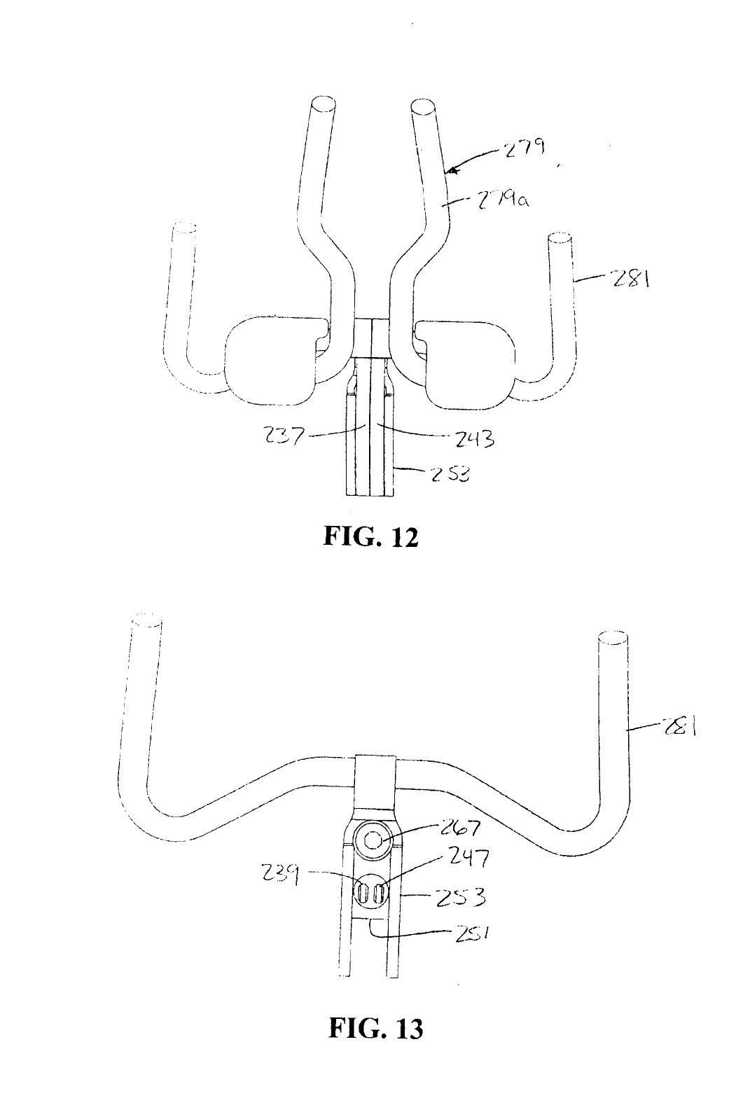

As seen in FIG. 12 additional components 279 may be attached to the levers 237 and 243 for this purpose, including gear shifting and brake components. The particular additional components shown in FIG. 12 are aerobar extensions 279a that adapt the levers to function substantially like aerobars. As seen in FIGS. 12 and 13, a separate handlebar 281 may be secured to the stem 251, as well. Other components such as gearshift and brake components may be mounted on the levers, aerobars, or handlebars, if desired. FIG. 14 shows an alternative arrangement wherein handlebar extensions 281a are provided on the levers 237 and 243. Thus, embodiments of a steering arrangement on a bicycle, for example, may comprise handlebars together with levers and aerobar extensions, aerobar extensions on the levers alone, handlebar extensions on the lever alone or with handlebars, to name but a few possibilities.

As seen in FIG. 11, a bottom lock nut 283 can be provided to assist in securing a threaded bottom end 261b of the tube 261 to the bottom plate 255. A threaded top end 261t of the tube 261 can be screwed into an internally threaded extending portion 253e of the stem. Steering of a front wheel 285 (FIG. 2) mounted to the fork 265 can be accomplished either by turning the handlebar 281 or by turning the levers 237 and 243 relative to the frame 215. A yoke cover 251c (FIG. 11) can be provided to cover the left and right pivot members 235 and 245 and portions of the left and right crank rods 233 and 241 and portions of the left and right linkages 239 and 247.

While the present invention has been described largely in connection with its use in a bicycle, it will be appreciated that the present invention has numerous applications, such as for use on exercise equipment, wheelchairs, or other rider-propelled devices.

While the present invention has been described largely in connection with an embodiment wherein gears are used as torque transmission elements, it will be noted that torque transmission occurs differently in other forms of torque transmission elements such as wheels and belts or sprockets and chains. Two adjacent gears will ordinarily transmit torque by turning in opposite rotational directions, while two connected sprockets or wheels will ordinarily transmit torque by turning in the same rotational direction. If torque transmission elements are used that transmit torque by turning in the same direction, then it may be desirable to reverse the orientation of freewheel-type bearing arrangements corresponding to one of the elements.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. A propulsion system, comprising:
a first torque transmission element;
a second torque transmission element, the first torque transmission element being adapted to transmit torque to the second torque transmission element; and
a first torque transmission element crank coupled to the first torque transmission element by a bearing arrangement that transmits torque to the first torque transmission element when the first torque transmission element crank is turned in a first rotational direction about an axis of the first torque transmission element and that permits the first crank to be turned freely relative to the first torque transmission element when the first torque transmission element crank is turned in a second rotational direction.

2. The propulsion system as set forth in claim 1, comprising a second first torque transmission element crank coupled to the first torque transmission element by a bearing arrangement that transmits torque to the first torque transmission element when the second first torque transmission element crank is turned in the first rotational direction about the axis of the first torque transmission element and that permits the second first torque transmission element crank to be turned freely relative to the first torque transmission element when the second first torque transmission element crank is turned in the second rotational direction.

3. The propulsion system as set forth in claim 1, comprising a second torque transmission element crank coupled to the second torque transmission element and adapted to transmit torque to the second torque transmission element when the second torque transmission element crank is turned in the second rotational direction.

4. A rider propelled vehicle, comprising:
a vehicle frame including a bracket;
a wheel rotatably mounted on the vehicle frame;
a propulsion system attached to the bracket, the propulsion system comprising a first torque transmission element, and a first torque transmission element crank coupled to the first torque transmission element by a freewheel that transmits torque to the first torque transmission element when the first torque transmission element crank is turned in a first rotational direction about an axis of the first torque transmission element and that permits the first torque transmission element crank to be turned freely relative to the first torque transmission element when the first torque transmission element crank is turned in a second rotational direction, and a second torque transmission element, the first torque transmission element being adapted to transmit torque to the second torque transmission element;
a chain wheel coupled to the second torque transmission element, the second torque transmission element being coupled to the chain wheel such that torque is transmitted between the second torque transmission element and the chain wheel when the first torque transmission element is turned in the first rotational direction;
a sprocket attached to the wheel; and
an endless chain extending around the chain wheel and the sprocket.

5. The vehicle as set forth in claim 4, comprising a crank rod pivotably attached to the first torque transmission element crank remote from axis of the first torque transmission element.

6. The vehicle as set forth in claim 5, comprising a lever pivotably mounted relative to the frame and linked to the crank rod such that pivotal movement of the lever is adapted to turn the first torque transmission element crank in the first rotational direction.

7. The vehicle as set forth in claim 6, wherein pivotal movement of the lever in at least one of the first and second lever rotational directions is adapted to turn the first torque transmission element crank in the first rotational direction.

8. The vehicle as set forth in claim 5, wherein the crank rod extends through a tubular portion of the frame.

9. The vehicle as set forth in claim 4, comprising a second torque transmission element crank coupled to the second torque transmission element and adapted to transmit torque to the second torque transmission element when the second torque transmission element crank is turned in the second rotational direction.

10. A bicycle comprising;
a frame comprising a top tube, a down tube, and a seat tube connected between the top tube and the down tube,
a fork comprising a steering column; and
a head tube assembly comprising a steering yoke attached to the top tube and the down tube, a stem and a bottom plate pivotably attached to a top end and a bottom end of the steering yoke, respectively, a tube attached at top and bottom ends thereof to the stem and the bottom plate, respectively, the steering column extending into and being fixed relative to the tube.

11. The bicycle as set forth in claim 10, comprising an arm pivotably attached to the stem.

12. The bicycle as set forth in claim 11, comprising a pivot member pivotably attached to the steering yoke, and a linkage member pivotably attached to a point on the arm remote from an axis of pivoting of the arm and the steering yoke and to the pivot member.

13. The bicycle as set forth in claim 12, comprising:
a wheel rotatably mounted on the vehicle frame;
a propulsion system attached to the bracket, the propulsion system comprising a first torque transmission element, and a first torque transmission element crank coupled to the first torque transmission element by a freewheel that transmits torque to the first torque transmission element when the first torque transmission element crank is turned in a first rotational direction about an axis of the first torque transmission element and that permits the first torque transmission element crank to be turned freely relative to the first torque transmission element when the first torque transmission element crank is turned in a second rotational direction, and a second torque transmission element, the first torque transmission element being adapted to transmit torque to the second torque transmission element; and
a crank rod pivotably attached at one end to the pivot member and at a second end to the first torque transmission element crank.

14. The bicycle as set forth in claim 13, wherein the crank rod extends through the down tube.

15. The bicycle as set forth in claim 13, comprising:
a second arm pivotably attached to the stem;
a second pivot member pivotably attached to the steering yoke;
a second linkage member pivotably attached to a point on the second arm remote from an axis of pivoting of the second arm and the steering yoke and to the second pivot member;
a second first torque transmission element crank coupled to the first torque transmission element by a bearing arrangement that transmits torque to the first torque transmission element when the second first torque transmission element crank is turned in the first rotational direction about the axis of the first torque transmission element and that permits the second first torque transmission element crank to be turned freely relative to the first torque transmission element when the second first torque transmission element crank is turned in the second rotational direction; and
a second crank rod pivotably attached at one end to the second pivot member and at a second end to the second first torque transmission element crank.

16. The bicycle as set forth in claim 15, wherein the first and second crank rods extend through the down tube.

17. The vehicle as set forth in claim 13, comprising a second torque transmission element crank coupled to the second torque transmission element and adapted to transmit torque to the second torque transmission element when the second torque transmission element crank is turned in the second rotational direction.

18. The bicycle as set forth in claim 10, comprising a handlebar attached to the stem.
